(19) United States
(12) Patent Application Publication
(10) Pub. No.: US 2009/0058120 A1
(43) Pub. Date: Mar. 5, 2009

(54) CENTER CONSOLE STRUCTURE OF VEHICLE

(75) Inventors: Tadashi IOKA, Hiroshima (JP); Yoshitaka INOUE, Hiroshima (JP)

Correspondence Address: Studebaker & Brackett PC, 1890 Preston White Drive, Suite 105, Reston, VA, 20191, US

(73) Assignee: MAZDA MOTOR CORPORATION, Hiroshima (JP)

(21) Appl. No.: 12/180,643

(22) Filed: Jul. 28, 2008

(30) Foreign Application Priority Data
Aug. 29, 2007 (JP) 2007-222995
Aug. 29, 2007 (JP) 2007-222996

(51) Int. Cl. B60R 27/00; B60H 1/32

(52) U.S. Cl. 296/24.34; 296/24.35

(57) ABSTRACT

A center console structure comprises a console body, a storage portion which is provided inside the console body so as to extend longitudinally having a specified height vertically and has an upper opening and a rear opening, an armrest which is provided so as to open and close the upper opening and has a rear vent at its rear portion, and a blower provided in front of the storage portion of the console body. The armrest connects to an air-conditioning air duct which is provided so as to connect to the blower and extends upward in front of the storage portion, and it has an inside duct inside.

### BACKGROUND OF THE INVENTION

The present invention relates to a center console structure in a vehicle compartment.

Japanese Patent Laid-Open Publication No. 10-016630, for example, discloses a conventional structure of a center console with a rear vent, in which a lid can be turned over so as to provide a temperature-conditioned cup holder. According to this structure, since the conditioning air is supplied from a portion near a rear seat, the conditioning air can reach a passenger seated in the rear seat properly. Also, Japanese Utility Model Laid-Open Publication No. 63-119446 discloses an armrest which opens forward and a storage portion which is accessible from both front and rear seats. The storage portion can be used by both passengers seated in the front and rear seats.

It may be preferable to provide a center console which has the above-described structures with the height of the storage portion being tall enough to accommodate a large bottle of 1.5 litters or more. Further, it may be preferable that a rear blower be disposed so that the amount of air supplied from the rear vent can be large enough. Herein, if the rear blower was disposed at a rear portion of the center console, a space in front of the rear seat would be restricted. Therefore, it may be preferable that the rear blower be disposed in front of the storage portion and the rear blower and the rear vent be interconnected via an air-conditioning air duct.

Herein, according to the center console disclosed in the former of the above-described patent publications, since the duct is disposed so as to extend longitudinally inside a console body, the storage portion may become small. Further, since the duct extends around the storage portion, it may bend so greatly that loss of the flow amount or the heat of the conditioning air flowing would become improperly large. Meanwhile, the latter of the above-described patent publications discloses no description regarding the rear vent and makes no suggestion about a structure in which the rear vent and an air-conditioning operational portion are disposed at the armrest.

Further, Japanese Patent Laid-Open Publication No. 2001-040932 discloses an armrest which opens both forward and rearward. This armrest's storage portion opening upward is easily accessible from both front and rear seats. Japanese Patent Laid-Open Publication No. 09-202168 discloses a temperature adjustable structure which comprises upper and lower storage portions 6, 11 which open at a console body 1 on its rear face and a temperature-controlled box 15 which opens upward. Thereby, there can be provided the temperature-adjustable storage portions for the front and seats

Herein, the armrest disclosed in the former of the above-described patent publications just opens forward and rearward, but does not become a cup holder. It has no lower storage portion opening at a rear and lower portion, either. Meanwhile, the structure disclosed in the latter may require an electric temperature adjusting device at the respective storage portions, so that a burden on a battery would be increased. It does not have the rear vent, rear blower, or air-conditioning air duct.

### SUMMARY OF THE INVENTION

The present invention has been devised in view of the above-described matters, and an object of the present invention is to provide a center console structure of a vehicle which can provide utilities to the both front and rear seats properly.

According to the present invention, there is provided a center console structure of a vehicle, which is located between both-side seats and in front of a rear seat, comprising a console body, an upper opening which opens at the console body on an upper side, a rear opening which opens at the console body on a rear side, a storage portion which is provided inside the console body so as to extend longitudinally having a specified height vertically and at least to connect to the rear opening, an armrest which is supported at the console body so as to open and close the upper opening, a rear vent provided at an upper portion of the storage portion, a blower provided in front of the storage portion of the console body, and an air-conditioning air duct which is provided so as to connect to the blower and supply conditioning air to the rear vent.

According to the present invention, since there are provided the upper opening and the armrest operative to open and close the upper opening, the proper utility for the front seat can be obtained. Further, since there are provided the rear opening without the armrest, the storage portion with the specified height and the rear vent positioned at a properly high level, the proper utility for the front seat can be obtained. Thus, the utilities to the both front and rear seats can be provided properly.

According to an embodiment of the present invention, the storage portion is configured to connect to the upper opening, and the armrest includes the rear vent which is formed at a rear portion thereof and an inside duct which interconnects the air-conditioning air duct and the rear vent. Thereby, the armrest with a proper height, the storage portion with the specified height which is accessible from the front and rear seats, the rear vent positioned at the properly high level, and the blower are constituted in a compact manner.

According to another embodiment of the present invention, the storage portion includes a storage box which has an upper opening and a rear face which forms a rear wall of the console body, the storage box being configured to be stored inside the console body and drawn rearward out of the console body. Thereby, the storage box drawn rearward is made be located so close to the rear seat that the utility for the rear seat can be improved.

According to another embodiment of the present invention, the storage box includes a shutter which is operative to close the upper opening so as to form a tray, the shutter being configured to move to a closing position thereof in which the shutter closes the upper opening when the storage box has been drawn rearward out of the console body. Thereby, the upper face of the storage box can be available as the rear tray, keeping the height of the rear vent in the properly high level.

According to another embodiment of the present invention, the air-conditioning air duct includes a conditioning-air nozzle which connects to an inside of the storage portion, and the storage box includes an inlet of the conditioning air supplied from the conditioning-air nozzle. Thereby, the temperature adjustment of the storage portion and the storage box are available.

According to another embodiment of the present invention, there is further provided a device operative to move the shutter to the closing position in a state in which the storage box is stored inside the console body. Thereby, the accessibility to the storage portion via the upper opening from the front seat can be improved.

According to another embodiment of the present invention, the storage portion is configured to be accessible via the upper opening in a state in which the storage box has been drawn rearward out of the console body. Thereby, the storage portion can be used effectively.

According to another embodiment of the present invention, an air-conditioning operational portion for a rear vent is provided at the rear face of the storage box. Thereby, the air-conditioning operational portion can be provided without narrowing the rear opening of the storage portion, and the storage box can be drawn further close to the rear seat.

According to another embodiment of the present invention, a shift lever is disposed in front of the armrest, the blower is disposed below the shift lever, a cup holder is disposed below and behind the shift lever, the armrest is disposed at a level which is lower than the shift lever and higher than the cup holder, and the air-conditioning air duct is provided so as to extend upward from the blower, passing below the cup holder. Thereby, the armrest can be disposed at a proper location, and the cup holder and the air-conditioning air duct can be disposed in the compact manner.

According to another embodiment of the present invention, an upper storage portion which connects to the upper opening is provided at the console body, the storage portion is provided below the upper storage portion, the rear vent is provided at a rear face of the console body above the storage portion, and the air-conditioning air duct is configured to extend between the upper storage and the storage portion and reach the rear vent. Thereby, despite a layout in which the blower is disposed in front of the upper storage portion and the storage portion and the rear vent is located rearward, the duct can be made properly short by utilizing a partition wall portion between the upper storage portion and the storage portion. Further, a preferable duct layout with less loss of the flow amount and the heat of the conditioning air flowing down and enlargement of the volume of the storage portions are compatible.

According to another embodiment of the present invention, the air-conditioning air duct forms a partition wall portion which partitions the upper storage portion from the storage portion, and there is provided a heat-exchanging portion which performs heat exchanging between conditioning air and the upper storage portion or the storage portion. Thereby, both the temperature adjustment and the volume enlargement of the storage portions can be provided with the common partition wall portion. Further, the storage space can be made as larger as possible because there is no gap formed between the respective storage portions and the duct.

According to another embodiment of the present invention, the armrest comprises an upper lid and a lower lid which have substantially the same height and external shape, the upper lid has an opening which is operative to connect to the rear vent when the upper lid is turned over rearward, and a tray portion is formed at a bottom face of the upper lid. Thereby, the upper lid can be the rear tray without substantially changing the height the armrest and without closing the rear vent.

According to another embodiment of the present invention, the air-conditioning air duct comprises a first duct which adjusts a temperature of the upper storage portion by using the conditioning air and a second duct which adjusts a temperature of the storage portion by using the conditioning air, and there are provided a conditioning-air separating portion which supplies the conditioning air having different temperatures to the first and second ducts and a conditioning-air mixing portion which mixes the conditioning air flowing down the first and second ducts respectively. Thereby, by using the conditioning air having different temperatures which flows down the both ducts and meets downstream, the different temperature adjustment can be provided for the storage portions, ensuring the supply of the conditioning air with an appropriate temperature to the rear seat.

According to another embodiment of the present invention, the armrest comprises a mechanism which enables the armrest to rotate forward around an axis provided at a front end of the upper storage portion or to rotate rearward around an axis provided at a rear end of the upper storage portion. Thereby, the upper storage potion is accessible from both the front and rear seats.

According to another embodiment of the present invention, a cup holder is provided above and in back of the blower, and a conditioning-air outlet of the conditioning air from the blower is provided below the cup holder. Thereby, the cup holder can be disposed in a compact manner between the blower and the air-conditioning air duct.

Other features, aspects, and advantages of the present invention will become apparent from the following description which refers to the accompanying drawings.

### BRIEF DESCRIPTION OF THE DRAWINGS

FIG. 1 is a schematic plan view of a vehicle compartment of a vehicle which is equipped with a center console structure according to a first embodiment of the present invention.

FIGS. 2A and 2B are perspective views of the center console structure.

FIG. 3 is a sectional view taken along line ii-ii of FIG. 2A.

FIGS. 4A and 4B are an upper view and a sectional view taken along line i-i of FIG. 1.

FIGS. 5A-5C are sectional views showing a shutter mechanism, which correspond to FIG. 4B.

FIG. 6 is a schematic plan view of the vehicle compartment of a vehicle which is equipped with a center console according to a second embodiment of the present invention.

FIGS. 7A-7D are perspective views of the center console.

FIG. 8 is a sectional view taken along line ii-ii of FIG. 7A.

FIG. 9 is a sectional view taken along line i-i of FIG. 6.

FIGS. 10A and 10B are views showing an opening and closing mechanism of an armrest.

FIG. 11 is a view showing a center console structure according to a third embodiment of the present invention, which corresponds to a sectional view taken along line ii-ii of FIG. 7A.

FIG. 12 is a view showing a center console structure according to a fourth embodiment of the present invention, which corresponds to a sectional view taken along line i-i of FIG. 6.

FIGS. 13A-13D are diagrams showing a connection structure of a blower and an air-conditioning air duct to achieve the fourth embodiment.

FIG. 14 is a diagram schematically showing a structure of an air conditioner.

FIG. 15 is a view showing the center console structure according to the fourth embodiment, which corresponds to a sectional view taken along line ii-ii of FIG. 7A.

FIG. 16 is a view showing a center console structure according to a modification of the fourth embodiment, which corresponds to a sectional view taken along line ii-ii of FIG. 7A.

### DETAILED DESCRIPTION OF THE INVENTION

Hereinafter, preferred embodiments of the present invention will be described referring to the accompanying drawings.

These are merely some examples of the present invention. The present invention should not be limited to these embodiments, and any other modifications and improvements may be applied within the scope of a spirit of the present invention.

### Embodiment 1

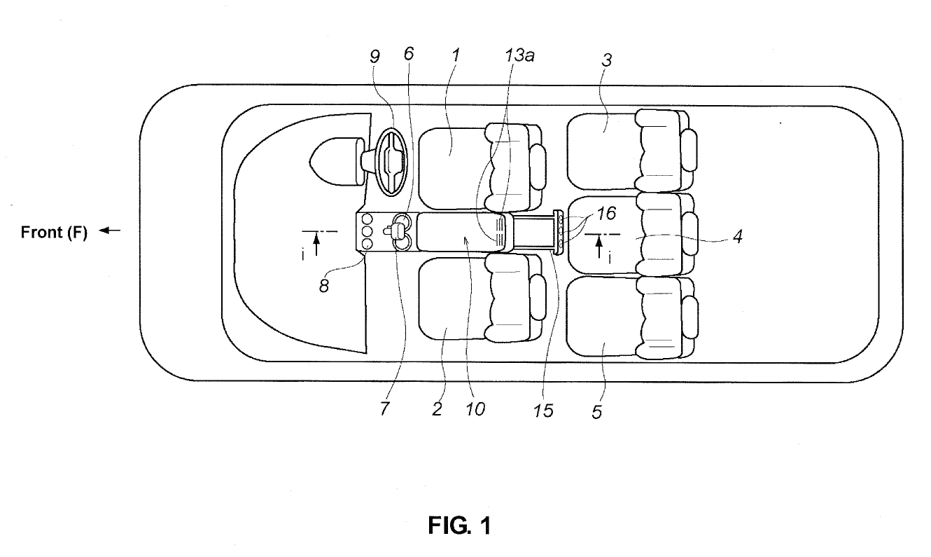

FIG. 1 is a schematic plan view of a vehicle compartment of a vehicle according to the present embodiment.

As shown in FIG. 1, a center console 10 is disposed between both-side front seats in the vehicle compartment, i.e., a driver's seat 1 and a passenger's seat 2. A cup holder 6 is provided in front of the center console 10. A shift lever 7 and an air-conditioning operational portion 8 for the front seats are disposed further before. A rear face of the center console 10 is located in front of a center rear seat 4. Beside the shift lever 7 is provided a steering wheel 9, a lower portion of which is located substantially at the same level as a knob of the shift lever 7.

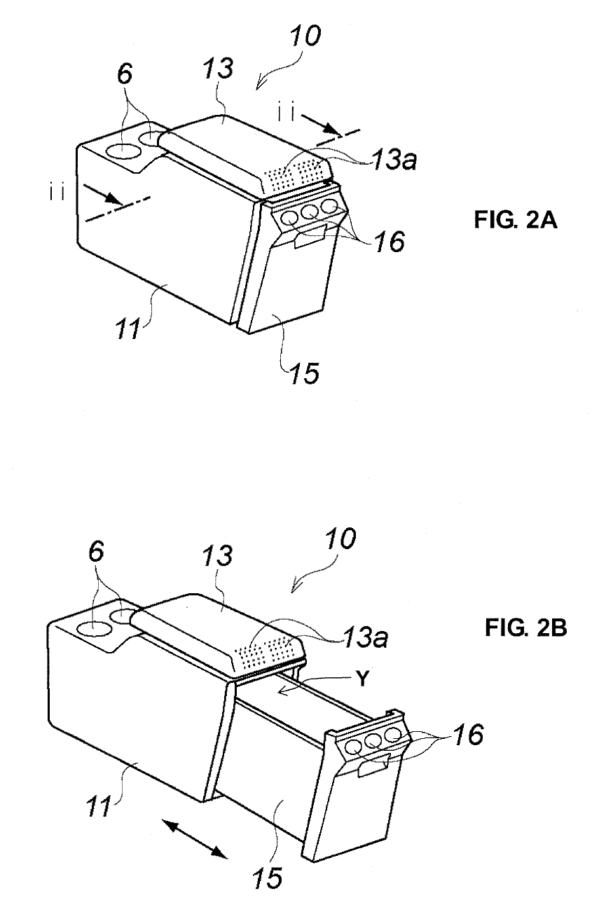

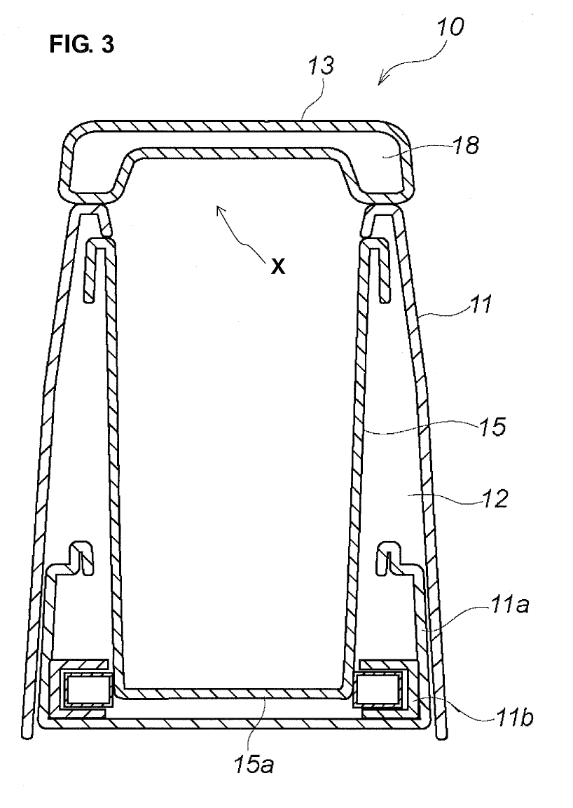

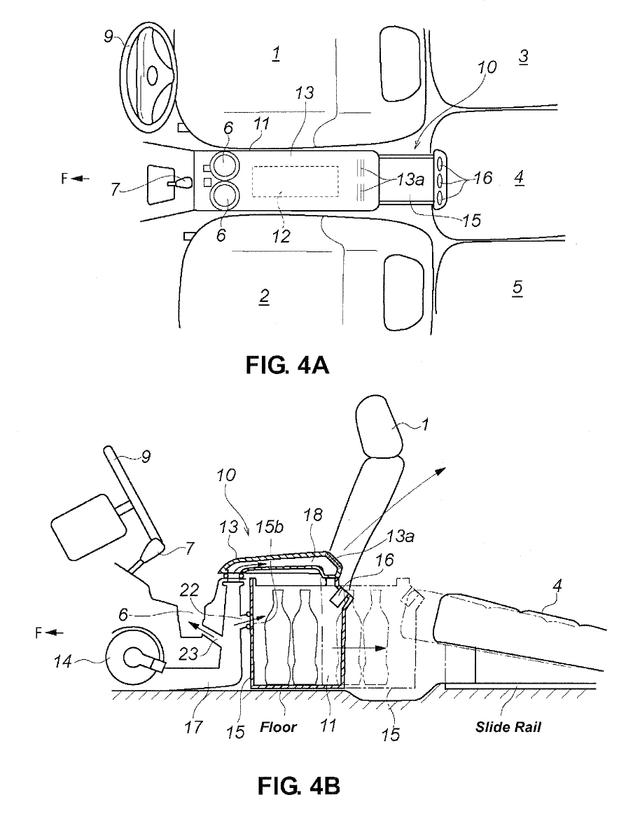

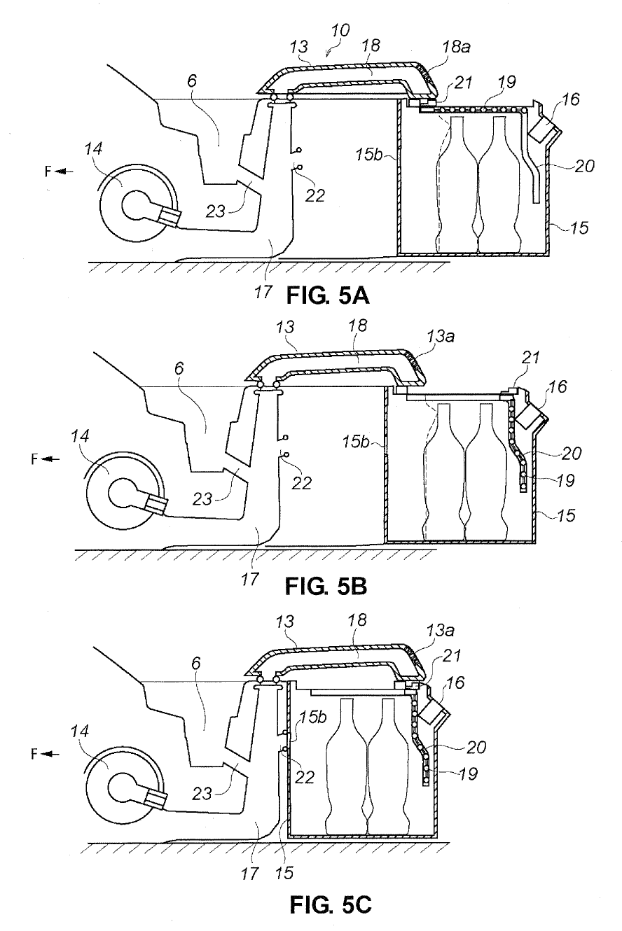

FIGS. 2A and 2B are perspective views showing a structure of the center console according to the present embodiment. FIG. 2A shows a state in which a storage box is stored, FIG. 2B shows a state in which the storage box is drawn out. FIG. 3 is a sectional view taken along line ii-ii of FIG. 2A. FIG. 4A is an upper view of FIG. 1, and FIG. 4B is a sectional view taken along line i-i of FIG. 1. FIGS. 5A, 5B and 5C are sectional views showing a shutter mechanism, which correspond to FIG. 4B. FIG. 5A shows a closing position of a shutter, and FIGS. 5B and 5C show an opening position of the shutter.

The center console 10, as shown in FIGS. 2 through 4, comprises a console body 11 which has a hollow box-shaped outer shape and extends in a vehicle longitudinal direction, a storage portion 12 which is provided inside the console body 11 so as to extend longitudinally having a specified height vertically (which is tall enough to accommodate a large pet bottle or others of 1.5 litters or more) and has an upper opening X and a rear opening Y, an armrest 13 which is supported at the console body 11 so as to open and close the upper opening X of the storage portion 12 and has a nozzle (rear vent) 13a formed at its rear portion which has an adjustable air-supply direction function, a blower 14 which is provided in front of the console body 11 and supply conditioning air.

The storage portion 12 includes a storage box 15 which has an upper opening and a rear face which forms a rear wall of the console body 11. The storage box 15 has a bottom portion 15a which is supported at a pair of slide rails 11b, and the storage box 15 is configured to be stored inside the console body 11 and drawn rearward out of the console body 11. Thereby, the storage box 15 drawn rearward is made be located so close to the center rear seat 4 that the utility for the rear seats can be improved.

An air-conditioning operational portion 16 for a rear vent (nozzles for the rear seats 3-5) is provided at the rear face of the storage box 15. Thereby, the air-conditioning operational portion 16 can be provided without narrowing the rear opening Y of the storage portion 12, and the storage box 15 can be drawn further close to the center rear seat 4. Further, even in a state in which the rear face of the storage box 15 drawn rearward contacts the center rear seat 4, the air-conditioning operation is available by using the air-conditioning operational portion 16 which is provided so as to face upward.

The armrest 13 includes an inside duct 18 which connects to an air-conditioning air duct 17, which extends upward from the blower 14 in front of the storage portion 12. Herein, in a state in which the armrest 13 is opened and the storage box 15 is drawn out of the console body 11, the storage portion 12 is accessible via the upper opening X of the console body 11, so that the inside space of the storage portion 12 can be used effectively.

As shown in FIG. 5, the storage box 15 includes a shutter 19 which is operative to close the upper opening so as to form a tray. Both end portions of the shutter 19 are supported at a guide rail 20 which is disposed so as to extend from the upper opening of the storage box 15 along its rear face. The shutter 19 is configured so that a lid knob 21, which is attached to one end of the shutter 19, slides on the guide rail 20, so that it can move between its opening position and its closing position as shown. The lid knob 21 is configured to engage with an inner wall of the console body 11 in a state in which the storage box 15 is stored in the console body 11. Thereby, according to the drawl of the storage box 15 out of the console body 11, the shutter 19 can be located at its closing position (closing the upper opening of the storage box 15, FIG. 5A). Thereby, the upper face of the storage box 15 can be available as the rear tray, and the temperature of the storage box 15 can be maintained. Further, by moving the lid knob 21 rearward in this state, the shutter 19 can be moved to its opening position (FIG. 5B). On the contrary, when the storage box 15 is moved to be stored in the console body 11 in a state in which the lid knob 21 engages with the console body 11, the shutter 19 is moved to its opening position (opening the upper opening of the storage box 15, FIG. 5C). Thereby, the shutter 19 is always open whenever the storage box 15 is stored by a passenger seated in the rear seat, so that the storage box 15 can be made in a state in which it is accessible from the front seat via the upper opening of the storage box 15, by opening the armrest 13.

The air-conditioning air duct 17 extending from the blower 14 includes a conditioning-air nozzle 22 which connects to the inside of the storage portion 12, and the storage box 15 includes an inlet 15b of the conditioning air supplied from the conditioning-air nozzle 22. Thereby, the temperature adjustment of the storage portion 12 and the storage box 15 are available.

Further, the air-conditioning air duct 17 includes a conditioning-air nozzle 23 which connects to the cup holder 6. Thereby, the conditioning air can be supplied to the cup holder 6.

Also, the shift lever 7 is disposed in front of the armrest 13 of the console body 11. The blower 14 is disposed below the shift lever 7, and the cup holder 6 is disposed below and behind the shift lever 7. The armrest 13 is disposed at a level which is lower than the shift lever 7 and higher than the cup holder 6. The air-conditioning air duct 17 is provided so as to extend upward from the blower 14, passing below the cup holder 6, and connect to the inside duct 18. Thereby, a driver can properly operate the sift lever 7 and the steering wheel 9 without any improper interference with a cup or the like in the cup holder 6. The armrest 13 can be disposed at a proper location so that the driver can easily put the cup or the like into the cup holder 6 or take them out of the cup holder 6. Also, the cup holder 6, the air-conditioning air duct 7, and the blower 14 can be disposed in the compact manner.

According to the above-described embodiment, the armrest 13, the storage portion 12 located at the proper level accessible from the front and rear seats 1-5, the rear vent 13a located at the higher level, and the air-conditioning operational portion 16 of the rear vent 13a can be disposed in the compact manner.

Although the lid knob 21 for the shutter 19 is configured to engage with the inner wall of the console body 11 in the above-described embodiment, an engaging portion operative to engage with the lid knob 21 for the shutter 19 in the closing position may be provided on a side of the storage box 15, and there may be provided an engagement portion, with which the lid knob 21 engages when the storage box 15 is stored in the console body 11, for opening the shutter 19. Thereby, the storage box 15 may be used as a container for objects soon after it has been drawn rearward, and it may be used as a tray when the shutter 19 has been closed.

### Embodiment 2

Hereinafter, a center console stricture according to a second embodiment of the present invention will be described. The same structures as those of the above-described first embodiment will be denoted by the same reference characters, detailed descriptions of which are omitted here.

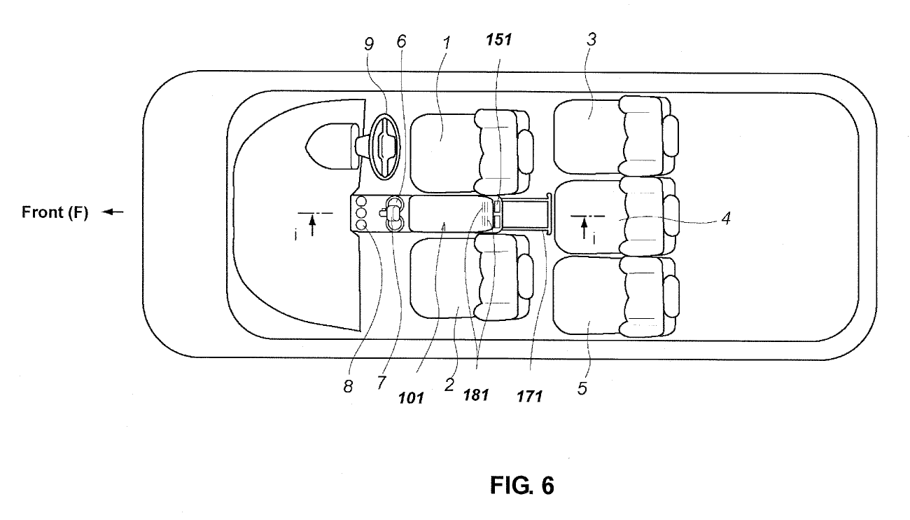

A center console 101 of the present embodiment is provided between the driver's seat 1 and the passenger's seat 2 likewise as shown in FIG. 6.

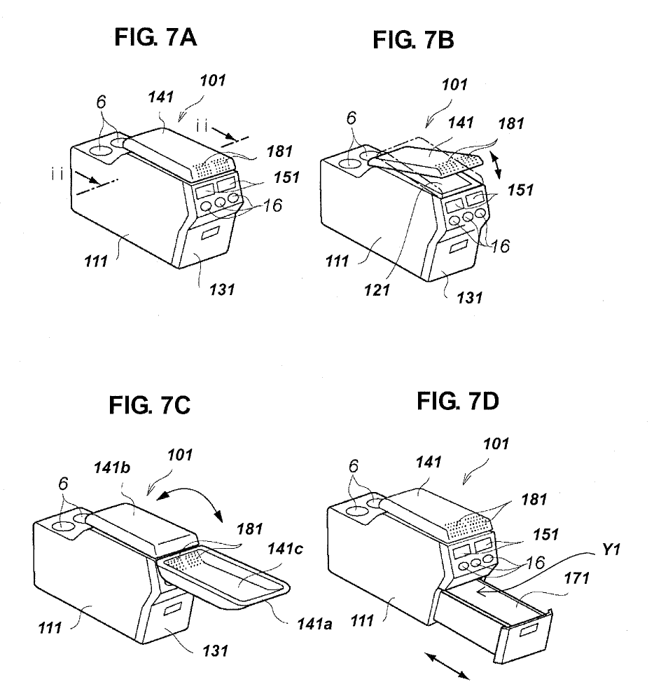

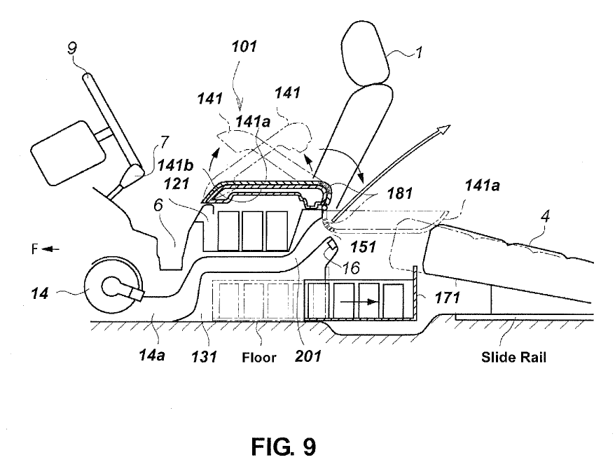

The center console 101, as shown in FIGS. 7-10, comprises a console body 111 which has the hollow box-shaped outer shape and extends in the vehicle longitudinal direction, an upper storage portion 121 which is provided inside the console body 111 and has an upper opening X1, a storage portion 131 which is provided below the upper storage portion 121 inside the console body 111 and has a rear opening Y1, and an armrest 141 which is supported at the console body 111 so as to open and close the upper opening X1 of the upper storage portion 121.

Further, at a portion between the storage portion 131 and the armrest 141 are provided a nozzle (rear vent) 151 which has an adjustable conditioning-air-supply direction function and an air-conditioning operational portion 16 for the rear seat (for the passenger seated in the rear seat).

The storage portion 131 includes a storage box 171 which has a rear face which forms a rear lower wall of the console body 111. The storage box 171 has upper edge portions 171a which are supported so as to slide relative to a bottom portion 111a of the console body 111, and the storage box 171 is configured to be stored inside the console body 111 and drawn rearward out of the console body 111. Thereby, the storage box 171 drawn rearward is be located so close to the center rear seat 4 that the utility for the rear seats can be improved.

Also, openings 181 are formed at the rear face of the armrest 141, i.e., at the rear face of the console body 111 above the storage portion 131. The blower 14 to supply the conditioning air is disposed in front of the upper storage portion 121 and the storage portion 131. The blower 14 and the rear vent 151 are interconnected via an air-conditioning air duct 201 which extends longitudinally inside the console body 111. The air-conditioning air duct 201 passes between the upper storage 121 and the storage portion 131 and connects to the rear vent 151.

Namely, the air-conditioning air duct 201 forms a partition wall portion 211 which partitions the upper storage portion 121 from the storage portion 131, and there is provided a heat-exchanging portion which performs heat exchanging between conditioning air flowing down the air-conditioning air duct 201 and the upper storage portion 121 or the storage portion 131. Specifically, the air-conditioning air duct 201 and the upper storage portion 121 or the storage portion 131 are interconnected via through holes 221, thereby the conditioning air flowing down the air-conditioning air duct 201 is supplied to the upper storage portion 121 and the storage portion 131.

The armrest 141 comprises an upper lid 141a and a lower lid 141b which have substantially the same height and external shape. The upper lid 141a has the above-described openings 181 which are operative to connect to the rear vent 151 when the upper lid 141a is turned over rearward, and a recess-shaped tray portion 141c is formed at a bottom face of the upper lid 141a. Thereby, the upper lid 141a can be the rear tray without substantially changing the height the armrest 141 and without closing the rear vent 151.

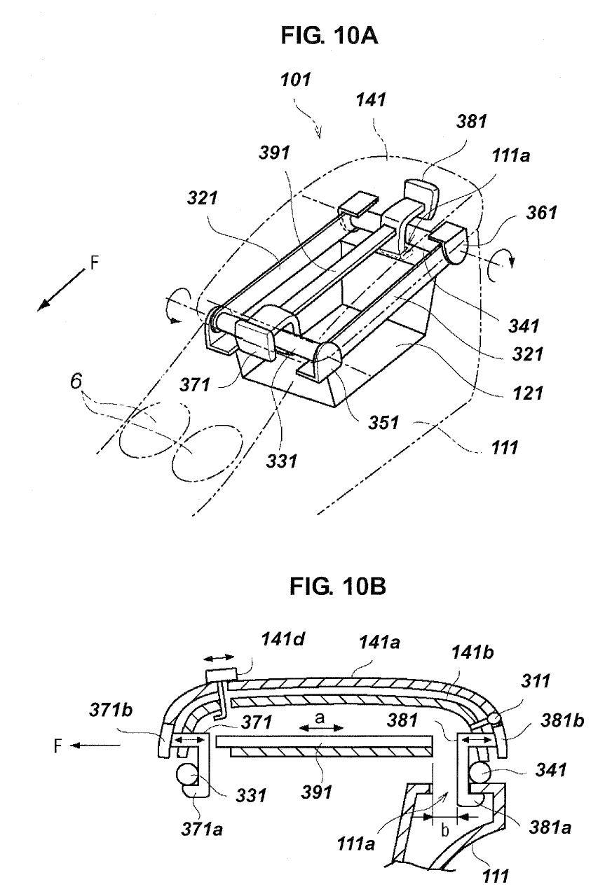

The armrest 141 with the upper lid 141a and the lower lid 141b comprises a mechanism (which will be described specifically by referring to FIG. 10) which enables the armrest 141 to rotate forward around an axis provided at a front end of the upper storage portion 121 and to rotate rearward around an axis provided at a rear end of the upper storage portion 121. Thereby, the upper storage portion 121 is accessible from the front and rear seats 1-5.

The cup holder 6 is disposed at an upper portion behind the blower 14, and a conditioning-air outlet 14a of the blower 14 connects to the air-conditioning air duct 201 extending below the cup holder 6. Thereby, the cup holder can be disposed between the blower 14 and the air-conditioning air duct 201 in a compact manner.

As shown in FIGS. 5A and 5B, the upper lid 141a and the lower lid 141b are configured to be detachable with a lock 141d and rotatable relative to each other around a hinge 311 provided at a rear end of the upper lid 141a. The armrest 141 comprises a pair of frames 321 which extends longitudinally in parallel to each other with a specified distance in the vehicle width direction, and front and rear end shafts 331, 341 which are pivotally supported at respective front and rear ends of the frames 321. Further, front and rear mounts 351, 361 which pivotally support the above-described shafts 331, 341 are provided. The mount 351 is fixed to the console body 111, while the mount 361 is fixed to the lower lid 141b.

The lower lid 141b is equipped with a front lock 371 and a rear lock 381 which are linked. The front and rear locks 371, 381 comprise hooks 371a, 381a, which are operative to slide longitudinally so as to engage with the front end shaft 331 and an engagement hole 111a formed at the console body 111, a link 391 which is operative to move one of the shafts to its engagement position when the engagement of the other shaft is released (disengaged), and operational knobs 371b, 381b which are operated to conduct an engagement/disengagement operation of the locks 371, 381.

The link 391, which is made of a rod member extending longitudinally, is configured to slide longitudinally away from the front lock 371 or the rear lock 381 by a specified distance a in such a manner that its front end contacts or gets away from the front lock 371 and its rear end contacts or gets away from the rear lock 381. Further, the respective locks 371, 381 are biased in the direction of engagement by biasing means such as a spring. Herein, it is set such that the above-described specified distance a is equal to a movable distance b of the locks 371, 381 or longer. And, when one of the locks 371, 381 is moved by the link 391 so that its engagement is released, the other of the locks 371, 381 is pushed by the link 391 in the direction of engagement as described above. Accordingly, the engagements of the both locks 371, 381 are prevented from being released at the same time.

According to the above-described embodiment, despite a layout in which the blower 14 is disposed in front of the upper storage portion 121 and the storage portion 131 and the rear vent 151 is located rearward, the duct can be made properly short by utilizing the partition wall portion between the upper storage portion 121 and the storage portion 131. Further, a preferable duct layout with less loss of the flow amount and the heat of the conditioning air flowing down and an enlargement of the volume of the storage portions are compatible. Further, the storage space can be made as larger as possible because there is no gap formed between the respective storage portions 121, 131 and the duct 201.

### Embodiment 3

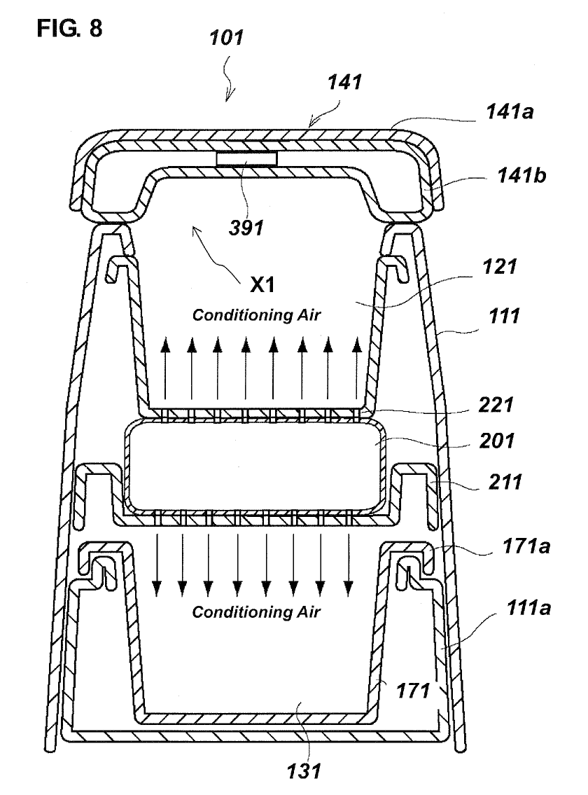

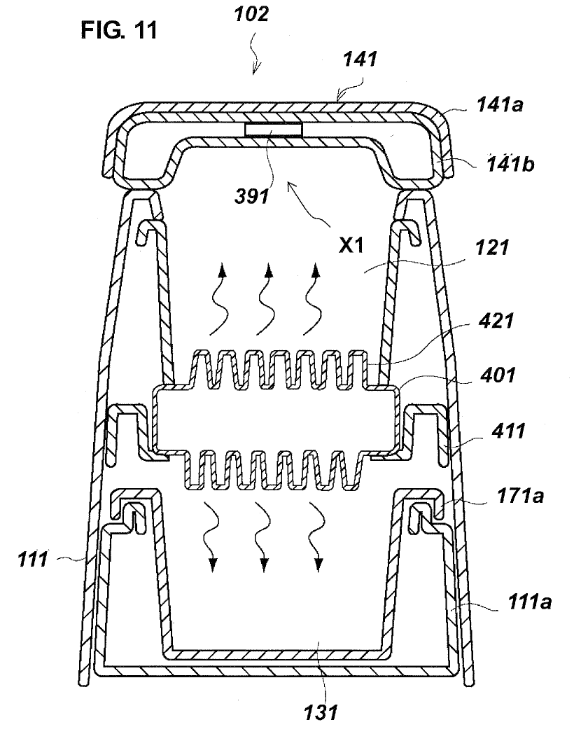

FIG. 11 is a view showing a structure of a center console 102 according to a third embodiment of the present invention, which corresponds to a sectional view taken along line ii-ii of FIG. 7A. The same structures as those in FIG. 8 are denoted by the same reference characters.

The heat-exchanging portion is comprised of the through holes 221 in the above-described second embodiment. According to the present embodiment, however, an air-conditioning air duct 401 is made of a heat-conductive metal or resin, such as aluminum alloy, which is supported at shelves 411, and further at the duct 401 are provided plural fins 421 as the heat-exchanging portion. These fins 421 can increase a surface area of the duct 401 which exposes to the upper storage portion 121 and the storage portion 131.

### Embodiment 4

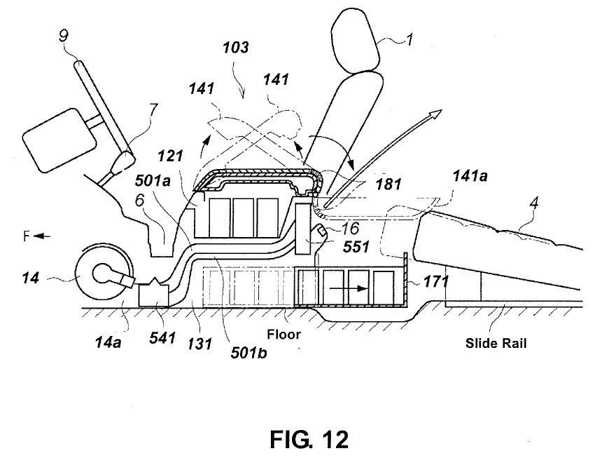

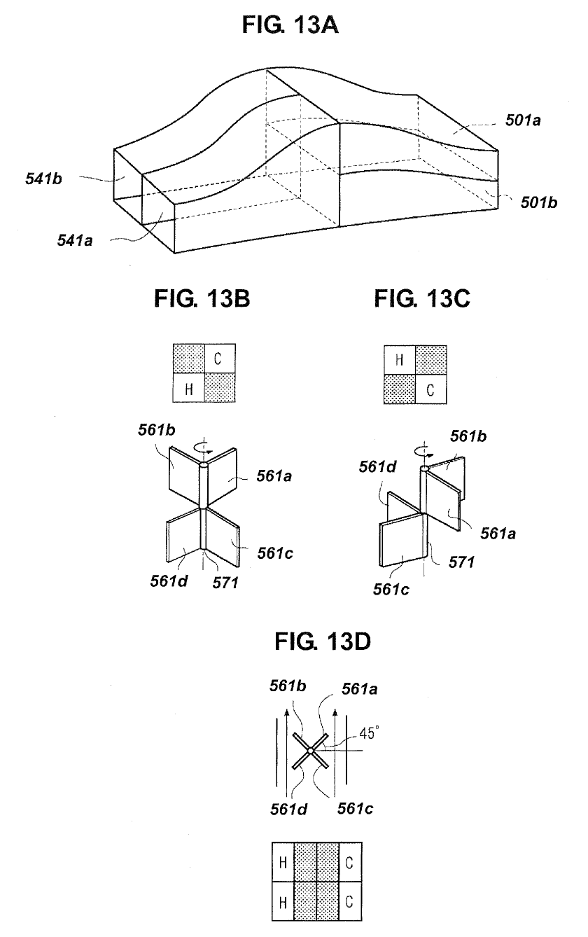

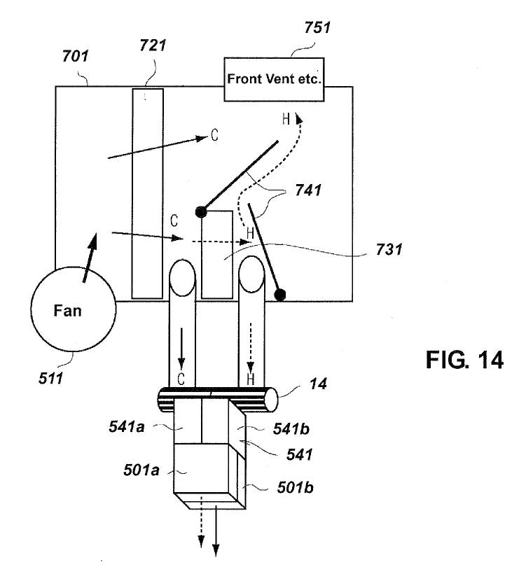

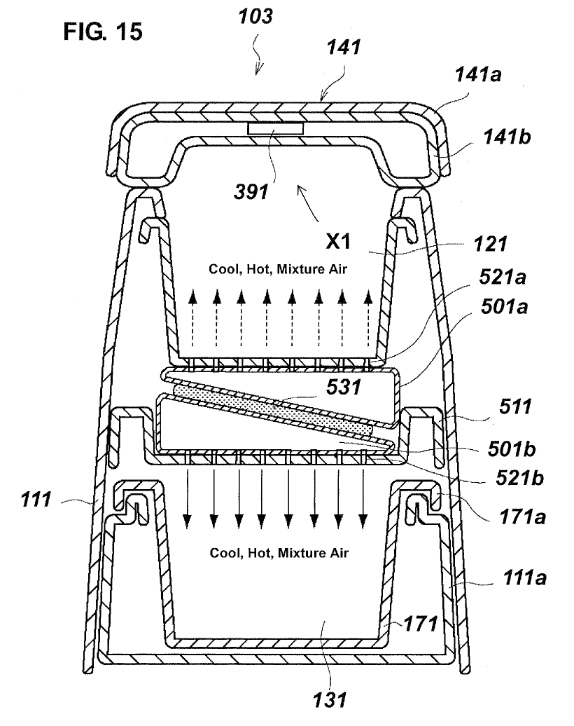

FIG. 12 is a view showing a structure of a center console 103 according to a fourth embodiment of the present invention, which corresponds to a sectional view taken along line i-i of FIG. 6. FIGS. 13A-13D are diagrams showing a connection structure of a blower and an air-conditioning air duct to achieve the fourth embodiment. FIG. 14 is a diagram schematically showing a structure of an air conditioner. FIG. 15 is a view showing the center console structure according to the fourth embodiment, which corresponds to a sectional view taken along line ii-ii of FIG. 7A. Herein, the same structures as those of the first, second or third embodiments are denoted by the same reference characters.

The air-conditioning air duct 201 of the above-described second embodiment is comprised of a single duct. According to the present embodiment, however, the duct is comprised of an air-conditioning air duct 501 which is comprised of two passages, an upper one and a lower one.

Specifically, as shown in FIGS. 12 and 15, the air-conditioning air duct 501 comprises an upper first duct 501a which adjusts the temperature of the upper storage portion 121 by using the conditioning air and a lower second duct 501b which adjusts the temperature of the storage portion 131 by using the conditioning air. The first duct 501a and the second duct 501b have a triangular passage section respectively, as shown in FIG. 15, and between these ducts 501a, 501b is provided a heat insulating material 531 to restrain a heat transfer therebetween. Through holes 521a which connects to the upper storage portion 121 are formed at the first duct 501a, and through holes 521b which connects to the storage portion 131 are formed at the second duct 501b.

Right downstream of the conditioning-air outlet 14a of the blower 14c is provided a conditioning-air separating portion 541 which separates and supplies the conditioning air having different temperatures (cool air C, hot air H, or fixed air of these) to the first and second ducts 501a, 501b.

Further, there is provided a conditioning-air mixing portion 551 which mixes the conditioning air flowing down the first and second ducts 501a, 501b, respectively. Then, the conditioning air mixed by the conditioning-air mixing portion 551 is supplied to the rear seats via the rear vent 151.

As shown in FIG. 13, a cool-air passage 541a and a hot-air passage 541b, which are separated from each other at the conditioning-air separating portion 541, connect to the first and second ducts 501a, 501b via a valve 561.

The valve 561 comprises an upper valve member which includes a first valve body 561a and a second valve body 561b, and a lower valve member which includes a third valve body 561c and a fourth valve body 561d. Herein, the first valve body 561a is operative to control connection or disconnection between the cool-air passage 541a and the first duct 501a. The second valve body 561b is operative to control connection (opening) or disconnection (closing) between the hot-air passage 541b and the first duct 501a. The third valve body 561a is operative to control connection (opening) or disconnection (closing) between the cool-air passage 541a and the second duct 501b. The fourth valve body 561d is operative to control connection (opening) or disconnection (closing) between the hot-air passage 541b and the second duct 501b. The upper valve member and the lower valve member are disposed relative to a drive axis 571 so that they are located up and down at intervals of an angle of 90 degrees as shown.

Herein, when the first and fourth valve bodies 561a, 561d take their opening positions, the second and third valve bodies 561b, 561c take their closing positions. In this state, the cool air C is supplied to the first duct 501a, and the hot air H is supplied to the second duct 501b, so that the upper storage portion 121 can be adjusted in the cool temperate atmosphere, while the storage portion 131 can be adjusted in the hot temperate atmosphere (FIG. 13B).

Further, when the second and third valve bodies 561b, 561c take their opening positions, the first and fourth valve bodies 561a, 561d take their closing positions. Thereby, the hot air H is supplied to the first duct 501a, and the cool air C is supplied to the second duct 501b. As a result, the upper storage portion 121 can be adjusted in the hot temperate atmosphere, while the storage portion 131 can be adjusted in the cool temperate atmosphere (FIG. 13C). Herein, it may be preferable considering keeping warm that the upper storage portion 121 be adjusted in the hot temperate atmosphere, and the storage portion 131 be adjusted in the cool temperate atmosphere.

Further, when the valve 561 is adjusted in such a manner that the first through fourth valve bodies 561a-561d are located with an angle position of about 45 degrees relative to the flowing direction of the conditioning air (FIG. 13D), these valve bodies 561a-561d take their partial opening positions. As a result, the mixture air of the hot air H and the cool air C can be supplied to the first and second ducts 501a, 501b respectively, so that the upper storage portion 121 and the storage portion 131 can be adjusted to substantial the same temperature.

As shown in FIG. 14, an air conditioner 701 generates the cool air C by making the outside air taken in by a fan 711 pass through an evaporator 721 and conducting beat exchanging, and it also generates the hot air H by making the cool air C pass through a heater 731. The flow of the generated cool air C and hot air H is controlled by air mixture dampers 741, so that at least one of the cool air C and the hot air H is supplied to a duct or a vent 751 for the front and the blower 14. The blower 14 is a cross flow fan or a sirocco fan, for example.

According to the present embodiment, the conditioning air having the different temperature can be supplied to the first and second ducts 501a, 501b, and the different temperature adjustment can be provided for the upper storage portion 121 and the storage portion 131, ensuring the supply of the conditioning air with an appropriate temperature to the rear seats 3-5.

### Modification of Fourth Embodiment

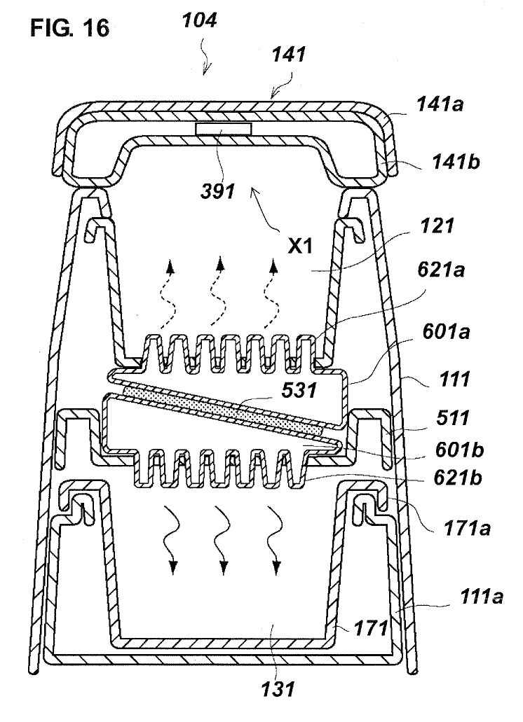

FIG. 16 is a view showing a structure of a center console 104 according to a modification of the fourth embodiment, which corresponds to a sectional view taken along line ii-ii of FIG. 7A. Herein, the same structures as those of the embodiment shown in FIG. 15 are denoted by the same reference characters.

The heat exchanging portion of the first and second ducts 501a, 501b of the above-described fourth embodiment are comprised of the through holes 521a, 521b. According to the present modification, however, first and second ducts 601a, 601b are made of a heat-conductive metal or resin, such as aluminum alloy, and further at the ducts 601a, 601b are provided plural fins 621a, 621b as the heat-exchanging portion. These fins 621a, 621b can increase the surface area of the ducts 621a, 621b which expose to the upper storage portion 121 and the storage portion 131.

What is claimed is:

1. A center console structure of a vehicle, which is located between both-side seats and in front of a rear seat, comprising:
a console body;
an upper opening which opens at the console body on an upper side;
a rear opening which opens at the console body on a rear side;
a storage portion which is provided inside the console body so as to extend longitudinally having a specified height vertically and at least to connect to the rear opening;
an armrest which is supported at the console body so as to open and close the upper opening;
a rear vent provided at an upper portion of the storage portion;
a blower provided in front of the storage portion of the console body; and
an air-conditioning air duct which is provided so as to connect to the blower and supply conditioning air to the rear vent.

2. The center console structure of a vehicle of claim 1, wherein said storage portion is configured to connect to said upper opening, and said armrest includes said rear vent which is formed at a rear portion thereof and an inside duct which interconnects said air-conditioning air duct and said rear vent.

3. The center console structure of a vehicle of claim 2, wherein said storage portion includes a storage box which has an upper opening and a rear face which forms a rear wall of said console body, the storage box being configured to be stored inside the console body and drawn rearward out of the console body.

4. The center console structure of a vehicle of claim 3, wherein said storage box includes a shutter which is operative to close said upper opening so as to form a tray, the shutter being configured to move to a closing position thereof in which the shutter closes the upper opening when the storage box has been drawn rearward out of the console body.

5. The center console structure of a vehicle of claim 4, wherein said air-conditioning air duct includes a conditioning-air nozzle which connects to an inside of the storage portion, and said storage box includes an inlet of the conditioning air supplied from the conditioning-air nozzle.

6. The center console structure of a vehicle of claim 5, wherein there is further provided a device operative to move said shutter to the closing position in a state in which the storage box is stored inside the console body.

7. The center console structure of a vehicle of claim 6, wherein said storage portion is configured to be accessible via said upper opening in a state in which the storage box has been drawn rearward out of the console body.

8. The center console structure of a vehicle of claim 7, wherein an air-conditioning operational portion for a rear vent is provided at the rear face of the storage box.

9. The center console structure of a vehicle of claim 3, wherein an air-conditioning operational portion for a rear vent is provided at the rear face of the storage box.

10. The center console structure of a vehicle of claim 3, wherein said air-conditioning air duct includes a conditioning-air nozzle which connects to an inside of the storage portion, and said storage box includes an inlet of the conditioning air supplied from the conditioning-air nozzle.

11. The center console structure of a vehicle of claim 3, wherein said storage portion is configured to be accessible via said upper opening in a state in which the storage box has been drawn rearward out of the console body.

12. The center console structure of a vehicle of claim 2, wherein a shift lever is disposed in front of said armrest, said blower is disposed below the shift lever, a cup holder is disposed below and behind the shift lever, the armrest is disposed at a level which is lower than the shift lever and higher than the cup holder, and said air-conditioning air duct is provided so as to extend upward from said blower, passing below the cup holder.

13. The center console structure of a vehicle of claim 1, wherein an upper storage portion which connects to said upper opening is provided at said console body, said storage portion is provided below the upper storage portion, said rear vent is provided at a rear face of the console body above the storage portion, and said air-conditioning air duct is configured to extend between the upper storage and the storage portion and reach the rear vent.

14. The center console structure of a vehicle of claim 13, wherein said air-conditioning air duct forms a partition wall portion which partitions said upper storage portion from said storage portion, and there is provided a heat-exchanging portion which performs heat exchanging between conditioning air and the upper storage portion or the storage portion.

15. The center console structure of a vehicle of claim 13, wherein said armrest comprises an upper lid and a lower lid which have substantially the same height and external shape, the upper lid has an opening which is operative to connect to said rear vent when the upper lid is turned over rearward, and a tray portion is formed at a bottom face of the upper lid.

16. The center console structure of a vehicle of claim 13, wherein said air-conditioning air duct comprises a first duct which adjusts a temperature of said upper storage portion by using the conditioning air and a second duct which adjusts a temperature of said storage portion by using the conditioning air, and there are provided a conditioning-air separating portion which supplies the conditioning air having different temperatures to the first and second ducts and a conditioning-air mixing portion which mixes the conditioning air flowing down the first and second ducts respectively.

17. The center console structure of a vehicle of claim 15, wherein said armrest comprises a mechanism which enables the armrest to rotate forward around an axis provided at a front end of the upper storage portion or to rotate rearward around an axis provided at a rear end of the upper storage portion.

18. The center console structure of a vehicle of claim 13, wherein a cup holder is provided above and in back of said blower, and a conditioning-air outlet of the conditioning air from the blower is provided below the cup holder.
